(19) United States
(12) Patent Application Publication
(10) Pub. No.: US 2026/0329735 A1
(43) Pub. Date: Oct. 22, 2026

(54) SYSTEMS AND METHODS FOR GENERATIVE ARTIFICIAL INTELLIGENCE ASSISTED MAINFRAME MODERNIZATION

(71) Applicant: JPMORGAN CHASE BANK, N.A., New York, NY (US)

(72) Inventors: Venkata Mohit TAMANAMPUDI, New Castle, DE (US); Lana GLUCK, Short Hills, NJ (US); Roman EISENBERG, Glen Rock, NJ (US); Gopinath P. SUNDARAM, East Brunswick, NJ (US)

(21) Appl. No.: 19/468,757

(22) Filed: Feb. 3, 2026

Related U.S. Application Data
(60) Provisional application No. 63/786,821, filed on Apr. 10, 2025.

(51) Int. Cl. G06F 11/3668; G06F 8/35; G06F 8/41

(52) U.S. Cl. CPC G06F 11/3688; G06F 8/35; G06F 8/41; G06F 11/3696

(57) ABSTRACT

In some embodiments, the techniques described herein relate to a method including: segmenting, by a chunker engine, a program into chunks; extracting, by a synthetic document agent, logic and documentation from each chunk of the chunks; connecting, by a test data agent, to a mainframe to extract real input/output data; regenerating and running, by a simulation agent, the program in a mainframe sandbox; generating, by a code generative agent, equivalent code and unit tests from the documentation; executing, by a test runner agent, the equivalent code and the program using the unit tests; computing, by a score keeper agent, a trust score based on output equivalence and test pass rate; graphing, by a graph database, outputs, traces, and entities from the executing of the equivalent code and the program of the unit tests; and identifying, by a backtrack agent, a failed step; and initiating, by the backtrack agent, a retry.

### BACKGROUND

### 1. Field of the Invention

Embodiments generally relate to systems and methods for generative artificial intelligence assisted mainframe modernization.

### 2. Description of the Related Art

Legacy mainframe systems, written in languages such as Assembler and Common Business-Oriented Language (“COBOL”), remain critical to industries like finance, telecommunications, and government. Despite their reliability and performance, these systems are costly to maintain, difficult to update, and increasingly incompatible with modern cloud-native architectures. In particular, complexity and aging technology stacks hinder adaptation to modern cloud-native environments. Further, conventional modernization efforts may frequently rely on manual refactoring or rule-based translation tools that fail to capture the full semantic nuances of legacy code, leading to costly and time-consuming rework. The dwindling pool of experts able to interpret such code further compounds the challenge. Further, conventional automated converters and machine learning-based approaches may generate incomplete or erroneous code and lack integrated validation and traceability, which necessitates extensive manual review and testing.

These challenges may be overcome by improved systems and methods include generative artificial intelligence (“Gen-AI”) assist solution for mainframe modernization. Improved systems and methods will leverage a multi-phase approach leveraging large language models (“LLMs”) for semantic understanding, documentation generation, multimodal diagram processing, and test synthesis. Improved systems and methods may store extracted data, semantic entities, and trust score relationships in a graph database for structured memory, traceability, and agent retrieval. Artificial intelligence framework-based agents coordinate across phases with self-correcting logic based on real and synthetic test data.

### SUMMARY

Exemplary embodiments provide systems and methods for generative artificial intelligence assisted mainframe modernization including a method including segmenting, by a chunker engine, a program into one or more chunks; extracting, by a synthetic document agent, logic and documentation from a (e.g., each) chunk of the one or more chunks; connecting, by a test data agent, to a mainframe to extract real input/output data; regenerating and running, by a simulation agent, the program in a mainframe sandbox; generating, by a code generative agent, equivalent code and unit tests from the documentation; executing, by a test runner agent, the equivalent code and the program using the unit tests; computing, by a score keeper agent, a trust score based on output equivalence and test pass rate; graphing, by a graph database, outputs, traces, and entities from the executing of the equivalent code and the program of the unit tests; and identifying, by a backtrack agent, a failed step; and initiating, by the backtrack agent, a retry.

In some embodiments, disclosed is a method that segments legacy programs into chunks, semantically documents a (e.g., each) chunk, extracts real mainframe input and/or output (“I/O”) data, regenerates and executes legacy behavior in a sandbox, generates modern code and unit tests, runs both legacy and modern paths on common datasets, computes a trust score from parity and test outcomes, persists lineage and results in a graph database, and uses a backtrack agent to localize failures and trigger targeted retries until a threshold is met.

Systems and methods may include iterative backtracking until a ≥90% trust threshold; trust score composition (e.g., unit test pass rate, legacy-modern output parity, semantic and diagram alignment, coverage); graph database schema for nodes and relationships enabling lineage and auditability; chunking based on control flow and call graphs; legacy regeneration for COBOL and/or Assembler in a sandbox; field-level parity diagnostics; diagram parsing by a vision model; generation of modular, framework-compliant code and integration tests; synthetic data constrained by entity schemas; dependency-aware failure localization; versioned score histories and confidence traces; Representational State Transfer (“REST”) and/or application programming interface (“API”), messaging, and persistence adapters; edge-case generation from constraints; and maintenance of an explainable audit trail across revalidation cycles.

Exemplary embodiments provide systems and methods for generative artificial intelligence assisted mainframe modernization including a method including refining the documentation with the updated logic; parsing, by a vision model agent, a newly uploaded architecture diagram; merging, by the vision model agent, the parsed information with the refined documentation; creating, by a code generative agent, a modular code using a query retrieval framework; generating, by a simulation agent, a synthetic test data aligning with the query retrieval framework; validating, by a test runner agent, execution of the modular code; evaluating, by a score keeper agent, a trust score; storing, by the score keeper agent, the trust score in a graph database; and revalidating, by a backtrack agent, the modular code if a trust score is less than a threshold.

Embodiments consistent with the present disclosure include a system including one or more processors and one or more storage devices storing instructions that when executed by one or more processors, cause the processor to perform one or more steps of the methods disclosed herein. Embodiments consistent with the present disclosure include a computer processing system, computer, or server, including: a memory configured to store instructions such as a non-transitory computer-readable storage medium; and a hardware processor operatively coupled to the memory for executing the instructions to perform one or more steps of the methods disclosed herein.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 is a block diagram of a system for generative artificial intelligence assisted mainframe modernization, in accordance with embodiments.

FIGS. 2A-2B are diagrams of methods for generative artificial intelligence assisted mainframe modernization, in accordance with embodiments.

FIG. 3 is a block diagram of a computing device for implementing certain aspects of the present disclosure.

### DETAILED DESCRIPTION

Embodiments generally relate to systems and methods for generative artificial intelligence assisted mainframe modernization.

Disclosed systems and methods provide several technical benefits that materially improve the process, reliability, and/or traceability of mainframe modernization. A disclosed architecture introduces a semantically aware pipeline that transforms legacy code into structured documentation and pseudocode before generation of modern implementations. By extracting entities, control structures, and/or flow logic into machine-actionable artifacts, the architecture reduces ambiguity inherent in direct code-to-code translation and improves determinism in subsequent steps. This semantic normalization enhances fidelity of regenerated legacy behavior and modern code synthesis, reducing error propagation across the pipeline.

Further, a dual-path execution and parity validation framework provides objective, automated correctness guarantees. Executing regenerated legacy program logic and modern implementations against identical datasets enables field-level and record-level equivalence checks, isolating behavioral divergences early. The resulting parity metrics feed a composite trust score that quantifies correctness across unit tests, coverage, semantic alignment, and/or diagram consistency. This continuous, quantitative validation substantially shortens feedback loops and improves the confidence of migration outcomes.

Further, the use of a graph database as a persistent, versioned memory may enable end-to-end lineage and explainability. Nodes representing chunks, entities, code modules, test runs, and/or diagrams, together with explicit relationships for usage, validation, and/or provenance, produce a navigable knowledge graph. This representation supports fine-grained impact analysis, targeted retries, and/or auditable traceability from legacy artifacts to modern services. The graph-backed memory improves retrieval-augmented generation for downstream agents, raising accuracy and consistency across iterative runs.

Further, an artificial intelligence agent may deliver targeted self-healing through dependency-aware retries. By localizing failures to specific chunks, modules, or test steps using graph relationships and diagnostic deltas, the system re-triggers only the necessary agents. This selective remediation may reduce redundant computation, accelerates convergence to the trust threshold, and prevents regression in validated components. The adaptive retry loop may be guided by score breakdowns, enabling data-driven prioritization of corrective actions.

Further, a disclosed method may unify multimodal inputs during the reimagine phase, where refined documentation and parsed architecture diagrams jointly condition code generation. Vision-driven extraction of services, APIs, and/or data flows, merged with textual specifications, yields more complete and consistent system designs. The resulting modern code may reflect explicit service boundaries, integration points, and/or persistence strategies that match the intended target architecture, reducing integration defects and post-migration rework.

Further, synthetic test data generation may extend coverage beyond limited production extracts. By aligning with entity schemas and inferred business rules, the system may produce realistic, edge-rich datasets that exercise boundary conditions and integration paths. The alignment improves defect detection during validation, elevates trust scores, and/or reduces the risk of latent issues surfacing after deployment.

Further, disclosed systems and methods improve performance and scalability of modernization tasks through parallelized, agent-driven orchestration. Agents may process chunks concurrently, execute tests in parallel, and/or update graph state incrementally. This parallelization may reduce overall migration time for large monoliths and may allow continuous integration of newly validated components into the modernization baseline.

Further disclosed systems and methods enhance maintainability and future evolution by generating modular, framework-compliant code with associated unit, integration, and/or regression tests. The presence of automatically produced tests and recorded lineage may simplify subsequent refactoring, compliance audits, and/or knowledge transfer to teams unfamiliar with the legacy domain. In addition, coverage metrics and score histories may guide ongoing quality improvements.

Further, a generation of a trust score may be a unifying quantitative signal enables consistent governance. By combining behavioral parity, test outcomes, semantic alignment, and/or diagram consistency into a single metric with a traceable breakdown, the system may enforce objective release criteria and facilitates automated gates in continuous integration (“CI”)/continuous delivery (“CD”) pipelines or cloud ecosystems. The combination may reduce subjective decision-making and standardizes acceptance across heterogeneous codebases.

Disclosed systems and methods reduce operational risk during migration. Regenerating and validating legacy behavior in a sandbox before switchover, coupled with comprehensive traceability and targeted backtracking, may lower the likelihood of production regressions. The explainable knowledge graph and versioned artifacts may support rapid incident diagnosis and rollback strategies, improving resilience and audit compliance throughout the modernization lifecycle.

These disclosed systems and methods overcome challenges facing conventional systems face numerous challenges that hinder effective modernization. Legacy environments often lack updated or accurate documentation, with critical institutional knowledge concentrated among retiring subject matter experts, which complicates logic extraction and system understanding. Monolithic, tightly coupled codebases create substantial risk for isolation and refactoring, while hidden dependencies such as job schedulers and batch interfaces are difficult to identify and trace. Dated tooling has limited modern support, impede integration with contemporary CI/CD and cloud ecosystems. Business continuity risks are heightened because these systems frequently power mission-critical workloads, such as banking and payroll, where downtime or migration defects may disrupt essential services. Test data and coverage are often inadequate; test environments may not reflect production behavior, and the absence of historical test cases complicates validation and regression testing. Organizational resistance to change arises from concerns over reliability, performance, and compliance, and from teams'unfamiliarity with new technology stacks. Costs and timelines escalate due to labor-intensive reverse engineering and rewrites, making return on investment difficult to justify without near-term benefits. Data migration introduces further complexity, particularly when moving virtual storage access method (“VSAM”), hierarchical, or proprietary databases to relational or non-structured query language (“NoSQL”) models, where data format and encoding inconsistencies are common. Regulatory and compliance barriers add additional constraints, as systems handling financial, healthcare, or governmental data must adhere to stringent security and audit standards, and/or rewriting logic without complete traceability may jeopardize compliance. Toolchain fragmentation across discovery, code generation, testing, and/or deployment results in poor interoperability and the absence of a unified orchestration pipeline, leading to operational inefficiencies and elevated project risk.

Techniques and systems described herein may include, through a discovery phase, AI agents semantically understanding and documenting legacy code, generate pseudocode, regenerate and execute the legacy version in a mainframe sandbox using extracted test data. Simultaneously, Java code and unit test cases are generated from the documentation and tested using the same mainframe input/output data. Agent steps may leverage LLM models for natural language and code understanding. Entity data and results are recorded in graph database. If a trust score <90%, a backtracking agent identifies and re-runs failing components until a (e.g., each) chunk meets the threshold.

Techniques and systems described herein may include, through a discovery phase, refining the documentation and upload enhanced architecture diagrams. AI agents powered by LLM vision models interpret the diagrams and documentation to generate code in a code framework. Synthetic test data is generated for test execution. Graph database (“DB”) may track the flow lineage and trust scores. If the score is below threshold, the system backtracks specific modules and reprocesses them until desired outcomes are achieved.

Benefits of disclosed embodiments include agent-driven autonomy where actions are coordinated by artificial intelligence agents with retry and validation logic; LLM integration for high accuracy semantic parsing, diagram interpretation, and/or code synthesis; graph database-backed memory that enables explainable, searchable, and/or connected knowledge for a (e.g., each) modernization run; multimodal workflow including vision and text-based processing enables complete system understanding; and backtracking and revalidation including ensuring every chunk or system component is trusted.

Benefits of systems and methods disclosed herein include an end-to-end, explainable modernization pipeline integrating LLMs, open-source AI agents, and/or graph DB memory. By enabling parallel validation, visual diagram understanding, and/or self-healing retries, disclosed systems and methods deliver scalable and verifiable modernization outcomes.

Benefits of systems and methods further include enabling real-time feedback from subject matter experts (“SMEs”) through embedded chat interfaces; voice-activated modernization interfaces for real-time voice feedback systems; real-time vision modernization; and building self-diagnostic artificial intelligence agents that adapt retry strategies using scoring analytics.

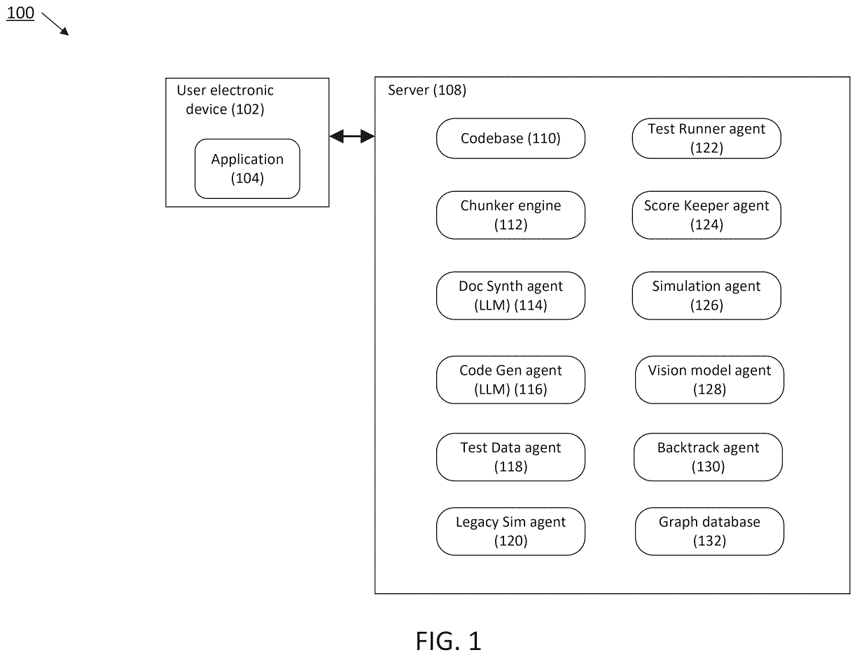

FIG. 1 is a block diagram of a system 100 for generative artificial intelligence assisted mainframe modernization, in accordance with embodiments.

System 100 includes user electronic device 102 configured to execute application 104 that provides interfaces for submitting legacy codebases, uploading documentation and architecture diagrams, reviewing generated artifacts, and/or approving remediation actions. A user electronic device 102 may execute an application 104 that may provide interfaces for submitting a legacy codebase, uploading documentation and diagrams, configuring thresholds, and reviewing artifacts and trust results. The user electronic device 102 may communicate with a server 108 that may host coordinated components implementing discovery and reimagine phases. Within server 108, codebase 110 may store legacy programs and associated metadata.

Chunker engine 112 may ingest codebase 110 and may segment programs into smaller logical units based on a control flow and/or one or more subroutine boundaries. A control flow may be an order in which a program's statements, branches, and/or loops execute, governed by constructs such as conditionals (e.g., if/else), loops (e.g., for/while, PERFORM), jumps/branches (e.g., GOTO/branch instructions), and subroutine or function calls. The control flow may define the paths data and execution may take through the program, including entry/exit points, decision points, and/or iteration. A subroutine boundary may be the interface and extent of a callable unit of code, such as a function, a procedure, a paragraph, or a section, marked by where control enters the subroutine (e.g., an entry point) and where control returns to the caller (e.g., an exit/return). In COBOL, for example, a paragraph or section invoked by PERFORM defines a subroutine boundary; in Assembler, a labeled routine entered via a branch-and-link and exited via a return instruction defines the boundary. Boundaries may demarcate local variables, pre/postconditions, and/or side effects, and are critical for modular analysis, chunking, and/or testing. Chunker engine 112 may produce chunk identifiers and metadata that downstream agents may use to maintain lineage and testability. Smaller logical units may be chosen based on the language example: Assembler—at submodule or section level; COBOL—at paragraph or sentence level. Chunker engine 112 may include logic to determine the language of the file and chunk the file based on the language accordingly.

The segmented outputs may be processed by document synthesis agent 114 that may generate structured documentation and pseudocode for a (e.g., each) chunk and may extract entities, constants, control structures, and/or logic descriptions. The structured documentation produced by document synthesis agent 114 may be consumed by a code generation agent 116 that may produce modern modular Java code and unit test classes while recording code lineage to the originating chunks. Test data agent 118 may connect to mainframe sources and/or mainframe environments to identify and extract real input and output datasets aligned with the entities identified by document synthesis agent 114, and may store dataset mappings to enable reproducible validations and parity comparisons. Mainframe sources may be one or more data and interface systems that a legacy mainframe application reads from or writes to, including VSAM files, sequential flat files, databases, tape archives, queues and topics, transactions, and/or external feeds and batch artifacts such as defined datasets, system management facility (“SMF”) logs, copybooks, and/or cataloged procedures managed by schedulers. A mainframe environment may be a runtime and operational ecosystem where mainframe applications execute and are managed, typically comprising the operating system and subsystems, security frameworks, transaction monitors and middleware, gateways and file transfer services, execution contexts, regions, initiators, batch job classes, configurations, and/or domain driven (“DD”) statements, and tooling for compilation, link-edit, dataset catalogs, performance monitoring, scheduling, and/or backup or disaster recovery systems. In the modernization workflow, a test data agent may interface with mainframe sources to extract real I/O datasets, while a legacy simulation agent may replicate aspects of the mainframe environment, such as code pages, transactional semantics, and/or file status codes, in a sandbox to validate behavior deterministically.

Outputs may be used for parity comparisons. Legacy simulation agent 120 may reconstruct legacy logic from the documentation and may execute the reconstructed behavior in a sandbox that may emulate mainframe runtime characteristics, and may generate execution logs and outputs that may serve as ground-truth references. Legacy logic may be business logic that was extracted from the legacy code (e.g., COBOL or Assembler) into documentation. Reconstructing legacy logic means attempting to re-create legacy code from the documentation. Sandbox may be a test environment similar to the original mainframe environment. For example, the sandbox environment may have similar screens, apps, flows as the mainframe main instance which creates the runtime characteristics. The main purpose of ensuring runtime characteristics may be to ensure re-generating the legacy logic from the documentation extracted and executed code outputs match the legacy code outputs.

Test runner agent 122 may perform dual-path validation by executing the regenerated legacy program logic from legacy simulation agent 120 and the modern code from code generation agent 116 against the common datasets provided by test data agent 118, and may collect pass and fail outcomes, parity deltas at field and record levels, error traces, performance statistics, and/or coverage metrics. Score keeper agent 124 may compute a trust score for a chunk, module, or subsystem based at least on output equivalence between the legacy and modern paths, unit test success rates, and/or semantic consistency with the documentation produced by document synthesis agent 114, and, during the reimagine phase, alignment with parsed architectural diagrams. For example, mainframe code may be monolithic and/or contained in one application but in the reimagine phase, the mainframe code is broken down by the chunker engine 112 into a micro-service event-based architecture. When the diagrams are parsed by vision model agent 128 as discussed further below, the new Java code that is generated may be broken down into multiple apps and APIs according to the architecture diagrams rather than being a monolith application. Whether code is effective or ineffective may be determined by the score keeper agent 124 based on how well the code is broken down according to an associated diagram. For example, if the architecture diagram has 12 APIs but only 5 APIs are generated and remaining 7 APIs are combined into 1 API, then the broken down code is unlikely to be effective or successful. The broken-down code may be considered effective when the newly generated code is aligned to the architectural pattern and generates 12 APIs or similar as per the diagram.

Simulation agent 126 may generate synthetic test data when real datasets are incomplete, aligning the synthetic data to entity schemas and inferred rules to expand coverage and exercise edge cases. Synthetic test data may be generated based on the application logic. For example, if an application generates a credit summary of a credit card statement, the agent may intake the code and generate a non-production, fabricated credit card statement with non-production, fabricated data so the application may use this non-production, fabricated statement to test the credit summary generation feature. Vision model agent 128 may parse uploaded architecture diagrams to infer services, APIs, queues, data stores, and/or boundaries, may merge the parsed representation with the refined documentation, and may provide architecture-conditioned context to the code generation agent 116 for generating target-architecture-aligned code and integration tests. The integration test may conform code to a service-oriented framework.

Vision model agent 128 may conduct a discovery phase to determine code information, such as entities, input/output signatures, call graphs, commit boundaries, and/or high fan-in/fan-out clusters, that may suggest natural service seams and event boundaries. The uploaded diagrams may be uploaded and parsed by the vision model agent 128 using determined code information, which may extract services, APIs, topics/queues, and/or data stores.

Vision model agent 128 may fuse visual cues from uploaded diagrams with discovery-phase evidence, including entities, input/output signatures, call graphs, commit boundaries, and/or high fan-in/fan-out clusters, to infer and refine parsed elements including service boundaries, API contracts, event topics or queues, and/or data store placements. For example, entities may anchor data ownership by revealing which logical groups of fields and records tend to co-evolve and vision model agent 128 may depict data ownership as ownership boundaries, which in turn may delineate service data models and their repositories. Vision model agent 128 may project the ownership boundaries onto diagram components by associating entity families with specific service boxes and database symbols, and may annotate read/write paths to data stores. As another example, input/output signatures may provide concrete interface shapes, including request/response schemas and record formats. Vision model agent 128 may thus propose API endpoints and event payload definitions aligned to input/output signatures that bind the API endpoints and event payload definitions to diagram edges between services or to message topics represented as queues or bus channels. Where synchronous patterns may be evident, vision model agent 128 may map input/output signatures to REST and/or remote procedure call (“RPC”) interfaces, and where asynchronous flows may be evident, vision model agent 128 may map input/output signatures to publish-subscribe topics with producers and consumers indicated by directional connectors.

Call graphs may reveal coupling patterns and invocation chains, allowing vision model agent 128 to separate orchestration roles from core domain responsibilities; tightly knit subgraphs may become individual services, while cross-cutting calls may be refactored into shared utilities or gateway services, and vision model agent 128 may reflect these partitions by reorganizing diagram nodes and clarifying interface arrows according to observed invocation direction and frequency. As another example, commit boundaries may signal transactional seams and compensation needs; vision model agent 128 may identify stages where state transitions occur and may introduce event emission points or saga orchestration nodes at those boundaries in the diagrams, marking them with transactional annotations and linking them to the corresponding service components and data stores to preserve atomicity expectations. As another example, high fan-in clusters may indicate aggregator or façade services that receive inputs from many sources and thus may warrant explicit API surfaces and caching or indexing data stores. As another example, high fan-out clusters may denote event hubs or change-data-capture publishers that feed multiple downstream consumers. Vision model agent 128 may render these hubs with centralized nodes and radiating connectors in the diagrams, tagging an (e.g., each) edge with the appropriate topic or API contract derived from the input/output signatures and entities.

In some embodiments, the parsed elements may be materialized as diagram primitives, such as service boxes annotated with owned entities and call graph roles, interface arrows labeled with API paths or message topics, and/or data store cylinders linked to read/write relationships, and a (e.g., each) diagram primitive may carry lineage to the underlying discovery artifacts so that traceability is preserved in the graph database. Where the diagram may be incomplete or ambiguous, the agent may propose additions or adjustments, such as introducing a queue between services at a commit boundary or splitting a service where the call graph suggests distinct bounded contexts, and may assign confidence scores based on the strength of alignment between visual features and discovery evidence. The resulting parsed representation may not only conform to the visual layout but may encode semantic constraints such as ownership, consistency, idempotency, and/or contract schemas, so that downstream code generation and synthetic testing may consume an authoritative, self-consistent architecture model.

The parsed elements may be cross-checked against structured documentation created by the document synthesis agent 114 and the entity and relationship knowledge stored in the graph database 132 for consistency. Simulation agent 126 may generate synthetic workloads aligned to the diagrammed flows to validate assumptions, while the score keeper agent 124 and backtrack agent 130 may feed diagnostic insights back into iterative diagram refinement. Governance may be provided by architecture review processes that approve the diagrams as baselines and record versions in graph database 132.

Backtrack agent 130 may monitor trust scores produced by score keeper agent 124 against a configurable threshold. When a score falls below the threshold, the backtrack agent 130 may retrieve and evaluate dependency relationships and diagnostic deltas to localize a cause of failure to a specific chunk, module, test case, or data mapping, and may selectively re-trigger one or more agents, including agents 114, 116, 118, 120, 122, 126, or 128, until the component may meet the acceptance criteria. The cause of failure may be a failed step (e.g., distinct line of code) and/or a misaligned artifact. A misaligned artifact in a software context refers to a call from a code or segment of code that appears when different parts of a system or process are out of sync, a link or library call is broken, or are improperly coordinated.

Graph database 132 may provide a persistent, versioned memory for one or more parsed components and may store nodes and relationships representing chunks, entities, code modules, tests, datasets, executions, diagrams, trust scores, and/or lineage. Nodes may be chunked data in the parent program. A (e.g., each) node may have attributes including chunks, entities, code modules, tests, datasets, executions, diagrams, trust scores, and/or lineage. Relationships may be based on chunks in the parent program or derived connections such as references to another chunk. The (e.g., each) node may be stored in a graph database such as Neo4j in the parent program. The graph-backed state may enable retrieval-augmented processing by the agents, may provide explainable traceability from legacy artifacts to modern implementations, and may maintain comprehensive audit trails across discovery and reimagine phases. The audit trail may include maintaining an explainable audit trail by recording, in the graph database, versioned documentation, code artifacts, diagram parses, execution traces, test outcomes, and/or trust score revisions associated with a (e.g., each) revalidation cycle. A revalidation cycle is an iterative loop in the modernization pipeline where components that do not meet a configured trust threshold are selectively reprocessed until they achieve acceptable confidence. After initial execution and scoring, diagnostic insights may localize failures to one or more of specific chunks, modules, interfaces, datasets, or rules. The backtrack agent may re-trigger targeted steps, such as refining documentation, adjusting code generation, regenerating legacy logic, augmenting or correcting test data, and/or re-running tests, under pinned configurations and versioned artifacts to ensure reproducibility. An (e.g., each) iteration of the revalidation cycle may produce one or more of updated outputs, parity comparisons, coverage metrics, and/or an amended trust score, may be persisted in the graph database with lineage. The cycle may continue until the trust score meets or exceeds the threshold or is escalated for human review, thereby ensuring that only validated and explainable components progress to subsequent phases.

In operation, application 104 on user electronic device 102 may initiate a modernization run by submitting the codebase 110 to server 108. The chunker engine 112 may segment (e.g., separate into smaller logical units) the code, the document synthesis agent 114 may produce documentation and pseudocode, the test data agent 118 may extract real datasets, and the legacy simulation agent 120 may execute reconstructed legacy behavior based on extracted documentation from legacy code, e.g., by attempting to reconstruct legacy code again from the documentation and tries to run the legacy code with test data and/or synthetic data. Code generation agent 116 may generate modern code and unit tests, and the test runner agent 122 may validate both paths using the same datasets. Score keeper agent 124 may compute trust scores with breakdowns and may persist them to the Graph database 132, which may record artifacts, lineage, traces, and/or diagram-to-code alignments provided by vision model agent 128. Breakdowns may include one or more of test success rate(s), diagram-to-code consistency, output correctness, and/or code coverage and execution quality. Score keeper agent 124 may calculate and/or normalize a score to 0-100. A (e.g., each) metric may be calculated or normalized to 0-100. If a (e.g., any) trust score is below threshold, backtrack agent 130 may initiate targeted retries (e.g., re-invoke attempts) guided by graph relationships. During the reimagine phase, vision model agent 128 and simulation agent 126 may extend validation with architecture-conditioned generation and synthetic test coverage. Together, the components identified in FIG. 1 deliver a controllable, explainable, and/or self-correcting pipeline for mainframe modernization.

Embodiments may include a two phase framework that transforms code into a transformed framework using Gen-AI. Embodiments include two-phase framework that transforms legacy code (e.g., a parent program) into modern applications using Gen-AI. A phase may be a discovery phase. The discovery phase may include an AI agent to semantically understand and document legacy code, generate pseudocode, regenerate and execute a legacy version in a mainframe sandbox using extracted test data. The discovery phase may include, simultaneously, generating code and unit test cases from the documentation and testing, the generated code using legacy mainframe input/output data. The discovery phase may include AI agent steps that may leverage LLM models for natural language and/or code understanding. The reimagine phase may include entity data and/or results that may be recorded in graph database. If trust score <90%, a backtracking agent may identify and/or re-run failing components until a (e.g., each) chunk meets the threshold. A phase may be a reimagine phase. The reimagine phase may include an application refining the documentation and upload enhanced architecture diagrams. The reimagine phase may include an AI agent powered by a LLM vision model interpreting the diagrams and documentation to generate code in a framework. The reimagine phase may include a synthetic test data generated for test execution. The reimagine phase may include a graph database tracking the flow lineage and trust scores. If the score is below threshold, the system may backtrack specific modules and reprocesses them until desired outcomes are achieved.

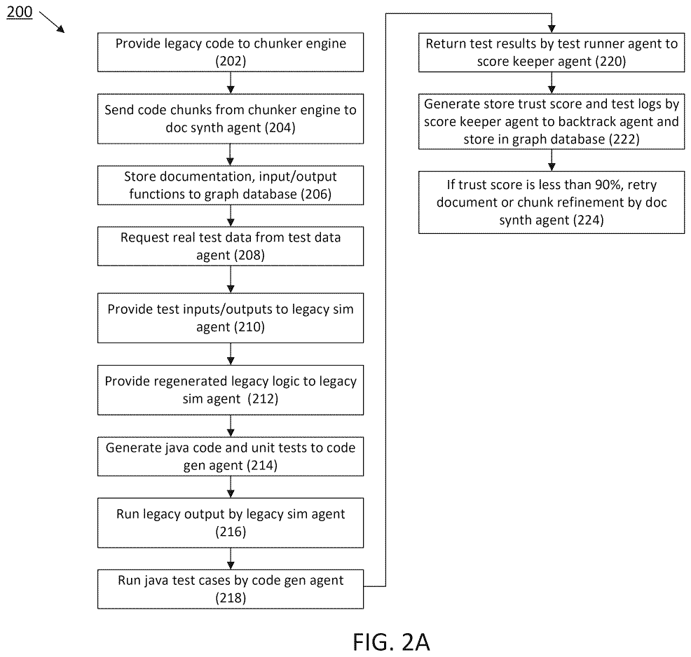

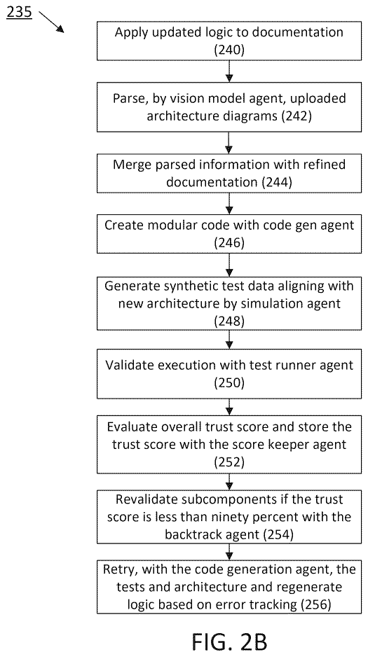

FIGS. 2A-2B are diagrams of methods for generative artificial intelligence assisted mainframe modernization, in accordance with embodiments.

FIG. 2A illustrates method 200 for generative artificial intelligence assisted mainframe modernization in the discovery phase.

At 202, a legacy codebase may be provided to a chunker engine that may analyze control flow, subroutine boundaries, and/or transaction interfaces to determine chunk boundaries. At 202, a legacy codebase may be provided to a chunker engine that may perform multi-stage ingestion and analysis to establish robust chunk boundaries and foundational metadata for downstream agents. The chunker engine may normalize and catalog source artifacts, including COBOL programs, assembler modules, copybooks, link-edit maps, job control language (“JCL”), file layout definitions, and/or external interface specifications. The engine may construct preliminary indices such as file-to-program mappings, call graphs, and/or control-flow graphs by parsing procedure divisions, PERFORM ranges (e.g., contiguous block of statements), GOTO/branch targets (e.g., specific code locations that control-flow statements jump to during execution), subroutine calls, macro expansions, and/or interrupt or input/output (“I/O”) handlers. The chunker engine may apply heuristics to identify natural segmentation points, including transaction entry routines, commit boundaries, file open/close operations, message queue interactions, and/or batch step transitions.

The chunker engine may further analyze data dependencies by tracing variable lifetimes, copybook inclusions, record structure usage, and/or condition code propagation to preserve or optimize, for a (e.g., each) chunk based on chunk boundaries, semantic cohesion, testability, and/or minimize cross-chunk leakage. The chunker engine may annotate a (e.g., each) candidate boundary with provenance and stability scores, considering factors such as cyclomatic complexity, fan-in/fan-out, and/or frequency of external resource interaction. To improve resilience, the engine may validate boundaries against runtime artifacts where available, including production logs, system management facility (“SMF”) records, or profiler traces, thereby reconciling static analysis with observed execution paths.

Once boundaries are finalized, the chunker engine may emit chunk descriptors that may include unique identifiers, source spans, dependent resources, entry/exit interfaces, environmental requirements, and/or estimated testability metrics. The engine may produce a segmentation manifest that may enumerate inter-chunk dependencies and ordering constraints, enabling parallel processing where safe and enforcing serialized handling where side effects or shared state could compromise determinism. Descriptors and/or manifests may be packaged with checksum and version metadata so downstream agents, such as the document synthesis agent and test data agent, may reliably retrieve, reproduce, and/or trace the chunked inputs throughout the pipeline.

At 204, the chunker engine may send resulting code chunks to a document synthesis agent, which may normalize syntax and may extract logic, entities, constants, control structures, and/or pseudocode for a (e.g., each) chunk. At 204, the chunker engine may send resulting code chunks to a document synthesis agent that may perform layered semantic analysis to transform raw legacy syntax into machine-actionable artifacts. The document synthesis agent may parse a (e.g., each) chunk's procedures, control structures, and/or data sections, and may reconcile copybook inclusions, macros, and/or conditional compilation directives to produce a normalized view of logic. The document synthesis agent may extract entities such as variables, constants, record fields, file handles, and/or transaction identifiers, and may annotate an (e.g., each) entity with type information, field lengths, encodings, scale/precision, and/or nullability where applicable. The agent may infer control-flow constructs, including loops, branches, error handlers, and/or commit points, and may convert them into structured pseudocode that may preserve execution order, preconditions, postconditions, and/or side effects.

The document synthesis agent may correlate chunk inputs and outputs with detected interfaces, including file reads/writes, message queue operations, screen transactions, and/or external calls, and may define I/O signatures that may standardize variable naming and cardinality across chunks. The document synthesis agent may identify latent business rules by analyzing predicate patterns, range checks, and/or table lookups, and may encode these rules as declarative annotations that may assist downstream generation and validation. To improve consistency, the agent may harmonize terminology using a domain glossary, may resolve synonyms and abbreviations, and may apply canonical naming schemes to reduce ambiguity in subsequent steps.

For provenance and traceability, the document synthesis agent may generate documentation artifacts that may include narrative descriptions of the chunk purpose, pseudocode, entity catalogs, interface specifications, and/or dependency lists. A (e.g., each) artifact may be versioned and may embed source spans and checksums referencing the originating codebase segments. The agent may compute complexity and testability metrics, such as cyclomatic complexity, estimated path count, and/or input/output coverage hints, that may guide prioritization and resource allocation. When prior runs may exist, the agent may incorporate retrieval-augmented context from the graph database to align extracted semantics with historical interpretations, thereby reducing drift. The resulting documentation package may be emitted with structured schemas so that downstream agents, such as the test data agent, legacy simulation agent, and/or code generation agent, that may consume the information deterministically and reproduce behaviors faithfully.

At 206, the document synthesis agent may store structured documentation and identified input/output functions in a graph database, along with relationships linking chunks to entities and provenance metadata. At 206, the document synthesis agent may store structured documentation and identified input/output functions in a graph database to establish persistent, queryable lineage for downstream processing. The agent may create nodes that may represent chunks, entities, interfaces, pseudocode blocks, business rules, and/or documentation artifacts, and may create relationships that may capture usage, dependency, and/or provenance, such as (:Chunk)-[:USES_ENTITY]->(:Entity), (:Chunk)-[:EXPOSES_I/O]->(:Interface), (:Artifact)-[:DERIVED_FROM]->(:SourceSpan), and/or (:Chunk)-[:DEPENDS_ON]->(:Chunk). A (e.g., each) node may include version identifiers, checksums, timestamps, and/or authorship or agent origin metadata to support reproducibility and auditability. Entity nodes may be annotated with type schemas, field lengths, encodings, precision, nullability, and/or validation constraints so that later steps may synthesize and verify datasets deterministically.

The agent may persist pseudocode and narrative documentation as linked artifacts that may reference exact source spans and control-flow regions, enabling fine-grained trace-back when discrepancies may arise. Interface nodes may describe I/O signatures, record formats, file identifiers, queue names, endpoint paths, and/or transaction codes, and may link to observed or expected cardinality and pre/postconditions. Business rule nodes may codify predicate logic, range checks, lookup tables, and/or transformation rules, and may be connected to the entities and control structures they govern, thereby creating a semantic scaffold for validation and code generation.

To facilitate efficient retrieval, the agent may index nodes and relationships using compound keys, such as program name plus line ranges, entity canonical names, and/or interface identifiers, and may attach search embeddings that may allow semantic queries by downstream agents. The agent may compute and store metrics that may guide orchestration, including cyclomatic complexity, estimated path counts, I/O intensity, and/or inferred testability scores. A segmentation manifest may be committed to the graph to record inter-chunk ordering constraints and safe parallelization groups. Access policies and role-based tags may be applied to sensitive entities and interfaces to maintain compliance with data governance requirements.

The storage operation may include consistency checks to ensure that entity references in pseudocode and documentation may align with the extracted schemas, and that interface definitions may match the chunk's declared inputs and outputs. If mismatches may be detected, the agent may log diagnostics and may mark affected nodes with validation flags for subsequent remediation by the backtrack agent. By establishing this graph-backed memory, 206 may enable explainable lineage from legacy code to modern artifacts, may support retrieval-augmented generation by other agents, and may provide a single source of truth for traceability, auditing, and/or iterative refinement throughout the modernization pipeline.

At 208, a test data agent may receive input/output identifiers and may request real test data from connected mainframe sources. At 208, a test data agent may request real test data from connected mainframe sources by leveraging the I/O signatures, entity schemas, and/or interface descriptors persisted at 206. The agent may establish secure sessions to data providers such as VSAM files, DB2 tables, IMS hierarchies, flat files, and/or message queues, and may negotiate access using credentials, role-based policies, and/or audit controls. The test data agent may formulate extraction plans that may specify record filters, key ranges, time windows, and/or transaction identifiers to capture representative and edge-case scenarios aligned with the chunk's declared inputs and outputs. The test data agent may reconcile code page encodings, packed decimal formats, binary fields, and/or custom delimiters, and may apply normalization routines to convert legacy encodings into canonical forms that downstream agents may process consistently.

To preserve traceability, the test data agent may record dataset provenance, including source locations, extraction timestamps, applied filters, and/or transformation steps, and may attach checksums to a (e.g., each) dataset slice. The test data agent may generate mappings from record fields to entity nodes and from entity nodes to record fields, thus ensuring bidirectional traceability, and may validate schema conformity by checking field lengths, types, and/or nullability constraints against the entity catalog. When discrepancies may be detected, such as missing fields, unexpected encodings, or referential integrity violations, the agent may flag the datasets with validation annotations and may produce diagnostic summaries to guide remediation. The agent may sample production logs or SMF records to align dataset selection with observed workload distributions, thereby improving the realism of validation runs.

Where sensitive data may be involved, the test data agent may apply masking or tokenization policies that may protect personal or confidential information while maintaining structural integrity for parity testing. The test data agent may partition datasets into training, validation, and/or stress-test cohorts and may tag a (e.g., each) cohort with intended use contexts. The agent may store extracted datasets and their lineage in the graph database, linking them to the corresponding chunk, interface, and/or entity nodes, and may compute dataset quality metrics such as coverage of value ranges, frequency histograms, and/or presence of boundary conditions. These operations may ensure that the subsequent execution steps may have reliable, representative inputs and that any deviations from expected schema or behavior may be surfaced early with actionable traceability.

At 210, the test data agent may provide aligned test inputs and outputs to a legacy simulation agent, including record schemas, field constraints, and/or dataset mappings. At 210, the test data agent may provide aligned test inputs and outputs to the legacy simulation agent by packaging datasets, schemas, and/or interface bindings into execution-ready bundles. The test data agent may assemble input records that may correspond to the chunk's declared entry points, may annotate a (e.g., each) record with entity-to-field mappings, and may include precondition flags such as initialization states, commit requirements, and/or error-handling expectations. The test data agent may generate configuration manifests that may specify file paths or DD names, queue endpoints, transaction codes, and/or environmental parameters, such as region identifiers, code pages, and/or decimal handling modes, so the legacy simulation agent may reproduce operational conditions faithfully.

The test data agent may attach schema descriptors that may declare field types, lengths, alignment, scale and precision, and/or nullability, and may include validation rules for range checks, referential integrity, and/or mandatory field presence. Where outputs may be known or previously observed, the agent may provide expected result templates that may define record shapes, key fields for comparison, tolerance thresholds for numeric rounding, and/or canonicalization routines for whitespace, date formats, or sign representation. The test data agent may include dataset partitions for baseline, edge-case, and/or stress scenarios, and may label a (e.g., each) partition with execution directives to control ordering, repeat counts, and/or concurrency settings.

To ensure determinism, the test data agent may compute and provide checksums for a (e.g., each) dataset slice and may embed version identifiers that may align with the entity and interface nodes persisted in the graph database. The test data agent may supply mapping tables for copybook expansions and field transformations so the legacy simulation agent may correctly interpret packed decimals, binary flags, and/or legacy encodings. If any dataset may contain masked or tokenized fields, the agent may append de-tokenization rules for permitted environments or substitute synthetic surrogates with documented constraints. The delivery bundle may further include logging instructions that may direct the legacy simulation agent to capture field-level traces and execution markers at critical checkpoints, enabling precise parity comparisons and diagnostic triage in subsequent steps.

At 212, the legacy simulation agent may generate regenerated legacy program logic from the documentation and may prepare executable artifacts for sandbox execution. The legacy simulation agent may generate regenerated legacy program logic from the documentation and may prepare executable artifacts for sandbox execution by performing a structured reconstruction pipeline. The agent may translate pseudocode and control-structure annotations into target legacy syntax, such as COBOL or Assembler, while preserving entry and exit conditions, commit boundaries, and/or error-handling semantics identified during documentation. The test data agent may resolve copybook references by synthesizing record layouts from the entity catalog and may insert appropriate MOVE, COMPUTE, and/or EVALUATE statements with field-level precision and rounding rules. For Assembler targets, the agent may emit macro expansions, register conventions, and/or linkage editor directives consistent with the original runtime model, and may configure I/O macros to align with declared file and transaction interfaces. The agent may generate JCL or execution descriptors that may define DD statements, dataset bindings, and/or step-level parameters, and may include environment-specific flags for code pages, decimal handling, and/or region identifiers to reproduce operational conditions.

The legacy simulation agent may perform static validation of the reconstructed source by checking reference integrity to copybooks, verifying type compatibility for arithmetic operations, and ensuring control-flow completeness for branches and/or fall-through paths. The legacy simulation agent may instrument the reconstructed code with diagnostic hooks that may capture field-level traces at predetermined checkpoints, including file reads and writes, transaction boundaries, and/or error paths, so subsequent parity analysis may be precise and reproducible. The legacy simulation agent may compile or assemble the reconstructed source and may link required libraries, generating executable artifacts and module maps that may document symbol resolution and external dependencies.

To prepare for sandbox execution, the legacy simulation agent may provision an emulated mainframe environment that may mimic file subsystems, transaction monitors, and/or message queues, and may load configuration manifests received from the test data agent. The legacy simulation agent may bind input datasets to declared DD names and interface endpoints, may initialize working storage with canonical defaults or specified preconditions, and may prime transaction queues with ordered test messages. The legacy simulation agent may conduct pre-run checks that may verify dataset accessibility, schema conformity, and/or environment readiness, and may produce readiness reports with checksums and version identifiers aligned to the graph database records. Where ambiguity may remain, for example, in arithmetic rounding modes or sign representation, the legacy simulation agent may select deterministic defaults and may record those selections as execution parameters linked to the corresponding chunk and interface nodes. By completing these preparations, 212 may ensure that the regenerated legacy program logic may execute consistently in the sandbox, produce traceable outputs for parity comparison, and/or maintain auditable lineage across reconstruction and execution phases.

At 214, a code generation agent may generate modern code (e.g., Java code) and associated unit tests based on the structured documentation for the chunk. The code generation agent may generate modern code (e.g., Java code) and associated unit tests from the structured documentation, pseudocode, and entity schemas produced in earlier steps. The code generation agent may construct an intermediate representation that may capture business rules, control flow, and/or I/O signatures, and may map these elements to architectural primitives such as services, controllers, mappers, repositories, and/or data transfer objects (“DTOs”). The code generation agent may apply canonical naming conventions and package structures, may create configuration descriptors for persistence, messaging, and/or external interfaces, and may select framework components that may correspond to the target runtime, including HTTP endpoints, queue listeners, schedulers, and/or transaction managers. The agent may synthesize data models that may reflect the entity catalog, preserving field types, precision, scale, and/or validation constraints, and may generate mapping logic that may translate legacy record formats into modern object representations with explicit nullability and range checks.

The code generation agent may translate control structures into structured methods that may implement preconditions, branching, iteration, and/or error handling with deterministic outcomes. The code generation agent may introduce domain-specific utilities for date and numeric normalization, rounding, and/or sign handling to match legacy behavior, and may embed idempotency guards and transaction boundaries where the documentation may indicate commit points or side-effecting operations. For persistence, the agent may generate repositories or data-access adapters that may encapsulate query logic and may enforce consistency with inferred referential relationships. Where external systems may be involved, the agent may create client stubs and interface contracts, and may provide configuration hooks for endpoint URLs, credentials, and/or retry policies.

To ensure testability, the code generation agent may produce unit tests and integration tests that may exercise nominal and edge-case paths derived from business rules and I/O signatures. The tests may include fixtures that may load baseline and boundary datasets, may verify field-level equivalence against expected outputs, and may assert invariants such as range constraints and referential integrity. The agent may generate coverage maps and may tag tests with identifiers that may correspond to chunk and rule nodes in the graph database, enabling traceable alignment between legacy logic and modern implementations. Mocking and stubbing of external dependencies may be included to isolate logic under test and to guarantee repeatable outcomes.

The code generation agent may output configuration files, build scripts, and/or CI descriptors that may define compile targets, dependency management, static analysis, and/or test execution pipelines. The code generation agent may compute and store code lineage metadata linking classes, methods, and/or tests to source pseudocode blocks, entities, and/or interfaces, and may persist these mappings in the graph database for downstream validation and auditability. Where architectural diagrams may be available, the agent may align generated components with parsed service boundaries and may produce orchestration code that may wire endpoints, message channels, and/or persistence adapters according to the diagram-derived topology. Prior to emission, the agent may run static checks, such as type consistency, null-safety, and/or rule completeness, and may record diagnostics and corrective transformations so subsequent scoring and backtracking may account for any inferred adaptations. By producing a comprehensive, framework-aligned code and test suite, 214 may establish a deterministic foundation for parity validation and iterative refinement in the modernization pipeline.

At 216, the legacy simulation agent may run the regenerated legacy program logic to produce legacy outputs, execution logs, and/or diagnostic traces. The legacy simulation agent may run the regenerated legacy program logic within a sandboxed environment to produce authoritative legacy outputs and detailed execution traces. The legacy simulation agent may initialize runtime services that may emulate file subsystems, transaction monitors, and/or messaging queues, and may load environment parameters, such as code pages, decimal rounding modes, and/or region identifiers, specified in the execution manifest. The legacy simulation agent may bind input datasets to declared DD names or interface endpoints, may allocate working storage with canonical defaults or specified preconditions, and may register checkpoint handlers that may capture state snapshots at critical boundaries, including file I/O operations, commit points, and/or error paths.

During execution, the legacy simulation agent may instrument field-level tracing that may record values entering and exiting computational statements (e.g., MOVE, COMPUTE, ADD, SUBTRACT, MULTIPLY, DIVIDE), may log predicate evaluations for EVALUATE and IF constructs, and may annotate record transformations with source and destination offsets to preserve provenance. For transaction-driven flows, the legacy simulation agent may simulate message ingestion order, concurrency settings, and/or time-based triggers to mirror operational sequencing; for batch flows, it may replicate step transitions, exit codes, and/or restart semantics. The sandbox may enforce determinism by serializing access to shared resources and by pinning configuration parameters so replays may yield identical outputs under identical inputs.

The legacy simulation agent may detect and record exceptional conditions, such as file status codes, decimal overflow, truncation, and/or invalid data encodings, and may attach diagnostic metadata to output artifacts, including offending record keys, field indices, and transformation contexts. The legacy simulation agent may compute and persist execution metrics such as elapsed time, instruction counts, I/O operation counts, and/or branch coverage to support performance baselines and parity comparisons with modern code. Output artifacts may include normalized record sets, transaction responses, and/or state-change logs; an (e.g., each) artifact may be tagged with checksums, version identifiers, and/or lineage links to the corresponding chunk, interface, and/or entity nodes in the graph database.

Upon completion, the legacy simulation agent may produce a consolidated execution report that may summarize pass/fail outcomes for operational checkpoints, may enumerate encountered anomalies with severity levels, and may provide correlation indices for aligning legacy outputs to expected templates supplied by the test data agent. The report may include a replay manifest enabling exact re-execution (e.g., capturing input selection, environment parameters, and/or instrumentation configuration) so subsequent analysis and backtracking may reproduce conditions precisely. The legacy outputs and trace data may be emitted to the test runner agent and may be persisted in the graph database, forming the ground-truth dataset for parity evaluation against modern implementations in later steps.

At 218, the code generation agent may run the Java test cases against the same datasets to produce modern outputs and coverage metrics. The code generation agent may run the Java test cases against the same datasets used by the legacy simulation to produce modern outputs and measurable coverage artifacts. The code generation agent may initialize a controlled runtime that may mirror configuration parameters affecting determinism, such as locale, character encodings, numeric rounding rules, and/or date/time handling, and may load environment descriptors that may bind input fixtures to service endpoints, repositories, and/or mappers generated in 214. The code generation agent may orchestrate execution of unit and integration tests in defined suites, may apply ordering constraints where data dependencies exist, and may enable parallel execution for independent scenarios to reduce total validation time.

During test execution, the code generation agent may instrument method-level and branch-level coverage, may capture assertions for field-level equivalence, and may log invariant checks derived from business rules, including range validations, referential integrity, and/or mandatory-field presence. For service-oriented components, the code generation agent may simulate HTTP and message queue interactions using embedded servers or in-memory brokers, and may record request/response payloads with correlation identifiers to align modern outputs with corresponding legacy records. For persistence adapters, the code generation agent may run tests against an isolated database or in-memory store seeded with canonical schemas and may record transaction boundaries and commit/rollback events to compare with legacy behavior.

The code generation agent may compute parity deltas by applying canonicalization routines consistent with legacy normalization, such as trimming whitespace, harmonizing sign representation, and/or applying fixed-precision rounding, and may produce diff artifacts that may enumerate mismatched fields, record keys, and/or transformation contexts. The code generation agent may aggregate coverage metrics, including line, branch, and/or mutation coverage where enabled, and may tag an (e.g., each) observation with test identifiers that may map back to chunk and rule nodes in the graph database. Performance statistics, such as execution time per test, throughput for batch scenarios, and/or latency for service calls, may be collected to establish baselines for later comparison.

Upon completion, the code generation agent may assemble a consolidated modern execution report that may list pass/fail outcomes, coverage summaries, parity diff counts, and/or anomaly classifications. The report may include reproducibility metadata, such as dependency versions, environment hash, and/or seed values for randomized generators, to ensure that reruns may yield consistent results. Modern outputs, logs, coverage artifacts, and/or diff results may be persisted to the graph database with lineage links to the originating chunks, tests, and/or code modules. The resulting dataset may be forwarded to the test runner and score keeper agents to support trust score computation and targeted remediation in subsequent steps.

At 220, a test runner agent may aggregate and normalize results from the legacy simulation and modern Java executions to produce a consolidated validation package for scoring. The test runner agent may align outputs using record keys, correlation identifiers, and/or interface bindings, and may apply canonicalization routines that may harmonize encodings, numeric precision, date formats, and/or whitespace policies so parity comparisons may be deterministic. The test runner agent may compute equivalence at multiple granularities, including field-level, record-level, and/or batch-level totals, and may generate diff artifacts that may enumerate mismatches with context such as source chunk, transformation rule, and test case identifier. The test runner agent may collate coverage metrics from modern tests and checkpoint coverage from legacy runs, may compute composite statistics such as pass/fail ratios, branch hit rates, and/or performance baselines, and may package logs, traces, and parity deltas with checksums and version tags for reproducible analysis. The consolidated validation package may be emitted to the score keeper agent and may be persisted to the graph database for lineage and auditability.

At 222, the score keeper agent may compute a trust score by evaluating the consolidated validation package against configurable criteria. The score keeper agent may combine weighted components that may include unit and integration test success rates, legacy-to-modern output parity at field and record levels, semantic consistency with documented business rules, and, when applicable, alignment between parsed architecture diagrams and generated code topology. The score keeper agent may generate a breakdown that may expose contributions of a (e.g., each) component, sensitivity to thresholds, and confidence traces that may reference specific logs, test cases, and/or graph nodes. The score keeper agent may store the trust score, breakdown, and/or supporting evidence in the graph database, linking them to chunk, module, interface, and/or test run nodes so downstream diagnostics may traverse provenance efficiently. The score keeper agent may publish a status signal to the backtrack agent indicating whether the score may meet or exceed the acceptance threshold and may attach remediation hints derived from parity deltas, uncovered branches, or rule inconsistencies.

At 224, when the trust score may be less than a configured threshold, such as ninety percent that represents a significant likelihood of trust and thus indicates a high likelihood of the validation package against configurable criteria, the backtrack agent may initiate targeted retries to remediate deficiencies while preserving validated artifacts. The backtrack agent may reiterate to attempt to increase one or more trust scores. The agent may query dependency relationships and diagnostic annotations in the graph database to localize likely causes to specific documentation elements, entities, code modules, or datasets. Based on this cause map, the backtrack agent may selectively re-trigger one or more agents, for example, the document synthesis agent to refine pseudocode or entity extraction, the test data agent to augment or correct datasets, the legacy simulation agent to adjust environment parameters or instrumentation, and the code generation agent to regenerate mappers, validations, or rounding policies. The legacy simulation agent may schedule reruns with constrained scopes, may enforce reproducibility by pinning environment hashes and dataset checksums, and may track a (e.g., each) retry as a versioned cycle with updated trust scores and evidence. The legacy simulation agent may loop iteratively until the component may achieve or exceed the threshold, or may escalate to manual review by attaching actionable diagnostics through the user interface, thereby ensuring that a (e.g., each) chunk may converge to an acceptable level of confidence before promotion.

FIG. 2B illustrates method 235 for the reimagine phase of generative artificial intelligence assisted mainframe modernization. This phase may operate after discovery has yielded validated semantics and parity baselines, and may focus on shaping a target-state architecture and producing modular modern implementations aligned with that architecture.

At 240, apply updated logic to documentation. Application teams may refine the structured documentation produced during discovery to reflect target-state business rules, deprecations, and/or enhancements. The refinements may include clarifying preconditions and postconditions, consolidating redundant branches, externalizing configuration, and/or documenting service-level objectives and nonfunctional requirements. The updated documentation may preserve lineage back to legacy chunks and may introduce target entities, event schemas, and/or new integration points. The refinements may be versioned and persisted in the graph database so that subsequent artifacts may trace to explicit rationale and change history.

At 242, parse, by a vision model agent, uploaded architecture diagrams. Teams may upload diagrams depicting service boundaries, APIs, queues, databases, caches, and/or external systems. The vision model agent may detect symbols, connectors, labels, and/or swim lanes, and may infer typed components (e.g., REST service, message topic, relational store), communication patterns (synchronous versus asynchronous), security zones, and/or deployment domains. The agent may normalize ambiguous labels using the glossary captured during discovery, may resolve synonyms, and may output a parsed architecture representation that may include components, interfaces, directionality, and/or cardinality. Confidence scores and extraction metadata may be recorded to assist validation and future edits.

At 244, merge parsed information with refined documentation. A merger engine may align diagram-derived components and flows with the updated documentation by matching entities, operation names, and/or interface signatures. Conflicts, such as a diagrammed service lacking a corresponding documented use case, may be flagged with remediation suggestions. The merged model may define service contracts, event schemas, data ownership, and/or cross-service dependencies, and may generate explicit mappings from legacy entities to target domain objects. The result may be a consolidated specification that may guide code generation and test synthesis, with full lineage to legacy artifacts, documentation edits, and/or diagram elements stored in the graph database.

At 246, create modular code with code generation agent. Using the merged specification, the code generation agent may produce service skeletons, controllers, DTOs, mappers, repositories, configuration modules, and/or orchestration logic consistent with the architecture. Where endpoints may be defined, the agent may generate REST routes or messaging listeners with validation annotations and/or permutations derived from entity constraints, referential relationships, and/or historical distributions. The edge cases may be generated from a graph database. The graph database may implement transaction boundaries and idempotency guards corresponding to documented business rules and may emit integration tests alongside unit tests. The agent may generate interface contracts and client stubs for inter-service calls, and may produce infrastructure-as-code or configuration descriptors to declare service wiring, environment variables, and secret bindings. Classes, methods, and/or tests may include lineage tags to the merged specification.

At 248, generate synthetic test data aligning with new architecture by simulation agent. The simulation agent may synthesize datasets for a (e.g., each) service boundary and integration path, respecting entity schemas, referential relationships, and invariants defined in the merged model. The simulation agent may produce event sequences to exercise asynchronous messaging, API payloads for positive and negative cases, and database states that may trigger edge conditions such as version conflicts or constraint violations. Distributions, boundary values, and/or rare combinations may be sampled to maximize defect detection. A (e.g., each) dataset may be labeled by scenario, service, and/or expected outcome, and may be accompanied by checksums and provenance links to ensure reproducibility and auditability.

At 250, validate execution with test runner agent. The test runner agent may deploy or simulate the generated services in an isolated environment, load synthetic datasets, and execute unit, integration, and/or end-to-end tests. For event-driven flows, the agent may orchestrate message publication order and concurrency to mirror realistic workloads. The test runner agent may collect response payloads, state transitions, and/or inter-service call traces, and may measure latency, throughput, and/or error rates. Failures may be correlated to specific contracts, rules, or components via lineage tags, with detailed diagnostics persisted for remediation.

At 252, evaluate overall trust score and store the trust score with the score keeper agent. The score keeper agent may compute a composite trust score that may incorporate test success rates, diagram-to-code consistency (e.g., a (e.g., each) diagrammed interface realized in code and tested), semantic alignment to refined documentation, and coverage metrics across services and integration paths. The score keeper agent may produce a breakdown by component and criterion, may attach confidence traces referencing tests, logs, and/or parsed diagram elements, and may persist the score and evidence to the graph database. Thresholds may be configured globally or per-service to account for criticality.

At 254, revalidate subcomponents if the trust score is less than ninety percent with the backtrack agent. The backtrack agent may analyze the score breakdown, parity deltas, and/or contract violations to localize faults to specific services, endpoints, mappers, or rules. The backtrack agent may query dependency relationships in the graph database to compute an impact set and may selectively re-trigger one or more agents: regenerate code for a service with corrected mappings, refine documentation to clarify edge cases, adjust diagram parsing for mislabeled components, or augment synthetic datasets to cover missing scenarios. Retries may be scoped to minimize disruption of validated artifacts, and a (e.g., each) cycle may be versioned with updated evidence and scores.

At 256, retry, with the code generation agent, the tests and architecture and regenerate logic based on error tracking. Guided by diagnostic insights, the pipeline may iteratively regenerate affected modules, update tests and data, and/or re-run validations until trust thresholds are met. For example, the code generation agent may select a mean case to establish a baseline and seek to reduce deviation from the baseline for other datasets by modifying code and thus importance of outliers that may represent errors or unusual cases may be minimized or avoided. As another example, when parity deltas may indicate recurring off-by-one errors and sign inversions on packed-decimal fields mapped to monetary amounts, the agent may regenerate mapper methods to apply banker's rounding at scale two, may enforce explicit HALF_EVEN rounding on arithmetic paths, may normalize trailing sign nibbles into negatives, and may centralize conversions in a NumericNormalizer utility injected into services that may touch affected entities; associated unit and integration tests may be updated to assert field-level equivalence after normalization. As another example, when execution traces may reveal boundary predicate misalignment, where legacy logic may evaluate a condition as inclusive while modern code may treat the condition as exclusive, the agent may regenerate the control-flow block to reflect inclusive comparisons, may propagate the corrected predicate into validation annotations, and may refactor guard clauses to maintain short-circuit semantics identical to the legacy order of evaluation; tests may be regenerated to include edge-case inputs exactly at the boundary to verify expected branch selection and downstream side effects. As another example, when differential artifacts and logs show mismatches (e.g., between modern execution results and legacy execution results) caused by extended binary coded decimal interchange code (“EBCDIC”)-to-Unicode transformation format (“UTF”)-8 transliteration, fixed-length field padding, or trimmed leading zeros in identifier fields, the agent may regenerate I/O adapters and data transfer object (“DTO”) mappers to preserve fixed-width padding using schema-specified fill characters, may apply canonical left-or right-trim only where legacy semantics may allow, and/or may use a CharacterSetTranslator configured for legacy code page mappings; the agent may inject canonicalization routines into request/response filters and may update tests to validate byte-accurate payloads and record layouts against expected templates. Error tracking records may include failing assertions, contract mismatches, schema discrepancies, and/or performance regressions, a (e.g., each) linked to precise code locations and specification elements. Upon convergence, the system may emit final modular code, comprehensive tests, synthetic data packs, and/or a complete lineage graph demonstrating diagram-to-code and documentation alignment, thereby completing the reimagine phase depicted in FIG. 2B.

For additional elements, the systems and methods may include an orchestration layer that schedules, prioritizes, and/or parallelizes agent activities across multiple modernization runs. This layer may maintain run contexts, allocate compute resources, and/or enforce rate limits for external connectors. Two primary modes may be supported: a discovery-first mode that may process large legacy portfolios chunk-by-chunk in parallel, and/or a service-consolidation mode that may assemble validated chunks into higher-level domains for coordinated reimagination. The orchestrator may expose policies for retry backoff, trust threshold gating, and/or artifact retention windows. The orchestrator may provide dry-run simulations that may estimate computational cost and elapsed time before execution.

For additional elements, the systems and methods may include, prior to chunking, a portfolio intake module may inventory repositories, job streams, scheduling metadata, and/or external interfaces to scope the modernization effort. The portfolio intake module may classify applications by technology, criticality, dependency density, and/or expected complexity, and may generate modernization waves that may sequence applications to minimize operational risk. This intake stage may not perform code transformation but may track ownership, SLAs, change windows, and/or compliance tags that may influence orchestration decisions.

For additional elements, the graph database may implement governed schemas for nodes and edges that define allowed properties and relationship types. Validation rules may ensure that entities cannot be referenced without a declared schema, that documentation artifacts must anchor to source spans, and that trust score nodes must link to concrete evidence artifacts. Role-based access control may restrict who may edit documentation nodes, upload diagrams, or approve threshold overrides. The graph may maintain temporal versions, allowing queries “as of” a particular modernization cycle, and may support compare operations that may highlight changes in entities, rules, or interfaces across runs.

For additional elements, the systems and methods may implement comprehensive security controls across ingestion, storage, and/or execution. Connectors to mainframe sources may use mutually authenticated channels and may enforce least-privilege credentials. Data handling may incorporate tokenization, masking, or differential privacy mechanisms for sensitive fields. The sandbox runtime may be isolated via containerization, dedicated subnets, and/or network policies that may prevent egress except for approved endpoints. Audit logs may capture access to sensitive datasets, configuration changes, diagram uploads, and/or trust threshold adjustments. Evidence packs for audits may bundle documentation, lineage, score breakdowns, and/or execution traces with cryptographic signatures to prevent tampering.

For additional elements, the systems and methods may include a review console that allows SMEs and application owners to propose edits to extracted documentation, approve code-generation suggestions, and/or annotate business rules. Suggested changes may be captured as review nodes linked to the affected artifacts and may require dual authorization before incorporation. The console may surface confidence gaps, ambiguous extractions, or potential contract violations and may allow reviewers to attach examples or additional test cases. Human inputs may be versioned and may influence subsequent agent behavior through retrieval-augmented prompts, thereby reducing drift across iterations.

For additional elements, the systems and methods may include where the platform may collect operational telemetry, including queue lengths for agents, average processing time per chunk, data-transfer volumes, and/or sandbox CPU and memory utilization. Service-level objectives may be defined for throughput, turnaround time per chunk, and/or failure rate of retries. Alerting may trigger when SLOs are at risk, prompting the orchestrator to scale workers, reassign priorities, or split modernization waves into smaller batches.

For additional elements, the systems and methods may include, to reduce runtime and cost, caching intermediate artifacts such as parsed copybooks, code embeddings, and/or diagram parses. Deduplication may identify identical or highly similar chunks across applications and may reuse documentation and test suites with minimal revalidation. The orchestrator may leverage spot capacity or burstable instances for noncritical stages, while pinning deterministic stages, such as parity comparison and scoring, to more stable compute tiers. Heuristics may decide when to expand synthetic data sets versus scheduling additional extractions from production-like sources, balancing coverage and cost.

For additional elements, the systems and methods may include where the framework may expose extension points for additional languages (e.g., Programming Language One (“PL/I”)), alternative modern targets (e.g., C #, Go), and/or extra deployment frameworks. Connectors may be pluggable for databases, queues, and/or monitoring systems. The code generation agent may support templating for enterprise standards, such as logging, metrics, tracing, and/or security interceptors, so generated services align with organizational conventions out of the box.

For additional elements, the systems and methods may include, upon meeting trust thresholds, assembling a release package that may include generated code, build and deployment descriptors, environment configuration templates, seeded databases, migration scripts, and/or a test catalog with execution instructions. The package may include a lineage manifest that may map a (e.g., each) service module to legacy chunks and entities, along with trust scores and coverage summaries. A handoff checklist may verify that operational runbooks, observability dashboards, and/or rollback strategies are included before promotion to staging or production environments.

For additional elements, the systems and methods may include, where some failures may stem from environmental inconsistencies or uncontrollable external dependencies. The system may classify such failures as transient or structural. Transient failures, such as connector timeouts, may trigger backoff and circuit-breaking; structural failures, such as missing copybooks or incompatible encodings, may create remediation tasks assigned to owners, with blockers recorded in the graph. The orchestrator may re-route around blocked components while continuing with independent chunks to maintain throughput.

For additional elements, the systems and methods may include, for portfolios where batch steps and services span multiple applications, a dependency resolver may compute modernization order that may respect shared files, message topics, and/or database schemas. The dependency resolver may recommend interface stabilization strategies (e.g., compatibility shims) and may orchestrate joint tests that may validate interactions across application boundaries. This resolver may store cross-application contracts and shared entity definitions in the graph, ensuring reuse and consistent enforcement.

For additional elements, the systems and methods may include the application UI on user electronic device 102 providing guided workflows, inline visualizations of chunk graphs, and/or side-by-side diffs of legacy versus modern outputs. Accessibility features may include keyboard navigation, screen reader support, and/or adjustable contrast. Contextual tooltips may explain trust scores, diagram elements, and/or rule annotations, facilitating onboarding of teams unfamiliar with the legacy domain.

For additional elements, the systems and methods may continuously learn from successful remediations by mining the graph for patterns: for example, frequent rounding mismatches for certain field types may lead the code generator to adopt improved numeric policies by default. Synthetic data generation strategies may evolve using coverage feedback and failure clustering, targeting untested paths in subsequent cycles. Governance rules may update as compliance frameworks change, with historical runs remaining queryable under prior policies for audit continuity.

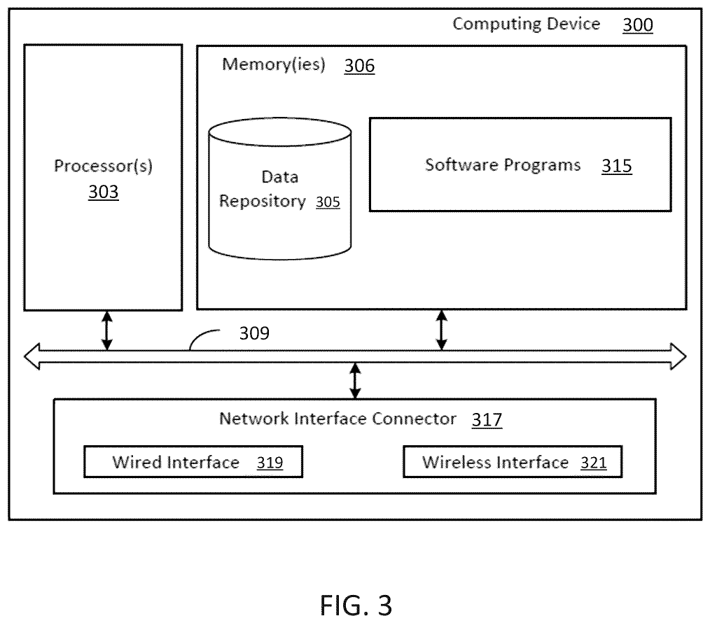

FIG. 3 is a block diagram of a computing device for implementing certain aspects of the present disclosure. FIG. 3 depicts exemplary computing device 300. Computing device 300 may represent hardware that executes the logic that drives the various system components described herein. For example, system components such as a user device, an interface, an event streaming platform, a matching algorithm, and/or various database/data store engines and servers, and other computer applications and logic may include, and/or execute on, components and configurations like, or similar to, computing device 300.

Computing device 300 includes a processor 303 coupled to a memory 306. Memory 306 may include volatile memory and/or persistent memory. The processor 303 executes computer-executable program code stored in memory 306, such as software programs 315. Software programs 315 may include one or more of the logical steps disclosed herein as a programmatic instruction, which may be executed by processor 303. Memory 306 may include data repository 305, which may be nonvolatile memory for data persistence. The processor 303 and the memory 306 may be coupled by a bus 309. In some examples, the bus 309 may be coupled to one or more network interface connectors 317, such as wired network interface 319, and/or wireless network interface 321. Computing device 300 may have user interface components, such as a screen for displaying graphical user interfaces and receiving input from the user, a mouse, a keyboard and/or other input/output components (not shown).

The various processing steps, logical steps, and/or data flows depicted in the figures and described in greater detail herein may be accomplished using some or all of the system components also described herein. In some implementations, the described logical steps may be performed in different sequences and various steps may be omitted. Additional steps may be performed along with some, or all of the steps shown in the depicted logical flow diagrams. Some steps may be performed simultaneously. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the invention or portions of the system of the invention may be in the form of a “processing machine” a “computing device,” an “electronic device,” a “mobile device,” etc. These may be a computer, a computer server, a host machine, etc. As used herein, the term “processing machine,” “computing device, “electronic device,” or the like is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular step, steps, task, or tasks, such as those steps/tasks described above. Such a set of instructions for performing a particular task may be characterized herein as an application, computer application, program, software program, or simply software. In one aspect, the processing machine may be or include a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example. The processing machine used to implement the invention may utilize a suitable operating system, and instructions may come directly or indirectly from the operating system.

The processing machine used to implement the invention may be a general-purpose computer. However, the processing machine described above may utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing machine be physically located in the same geographical place. That is, a (e.g., each) processor and the memories used by the processing machine may be located in geographically distinct locations and connected so as to communicate in any suitable manner. Additionally, it is appreciated that a (e.g., each) processor and/or memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various aspects of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. The medium may be a non-transitory computer-readable medium. The particular medium, i.e., the memory in the processing machine, utilized to hold the set of instructions and/or the data, may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some aspects of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many aspects and adaptations of the present invention other than those herein described, as well as many variations, modifications, and equivalent arrangements, will be apparent from or reasonably suggested by the present invention and foregoing description thereof, without departing from the substance or scope of the invention.

In instances of this disclosure where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Accordingly, while the present invention has been described here in detail in relation to its exemplary aspects, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such aspects, adaptations, variations, modifications, or equivalent arrangements.

1. A method for generative artificial intelligence assisted mainframe modernization, the method comprising:
segmenting, by a chunker engine, a legacy program into a plurality of chunks based on a control flow and a subroutine boundary;
extracting, by a document synthesis agent executing on a processor, a logic, an entity, a control structure, and a pseudocode from each chunk of the plurality of chunks to produce structured documentation;
connecting, by a test data agent, to a mainframe environment to identify and extract a real input dataset and a real output dataset corresponding to the entity extracted by the document synthesis agent to form an extracted dataset;
regenerating, by a legacy simulation agent, legacy program logic from the structured documentation and executing the regenerated legacy program logic in a sandbox using the extracted dataset to form regenerated legacy program logic;
generating, by a code generation agent, modern code and associated unit tests from the structured documentation;
executing, by a test runner agent, the regenerated legacy program logic and the modern code using common datasets;
computing, by a score keeper agent, a trust score based on a parity between a regenerated legacy program logic output and a modern code output and on a test pass rate;
persisting, by a graph database, an execution trace, the extracted entity, a plurality of documentation artifacts, a code lineage, and a test result associated with each chunk of the plurality of chunks; and
identifying, by a backtrack agent, a misaligned documentation artifact of the plurality of documentation artifacts and selectively initiating a retry to improve the trust score.

2. The method of claim 1, wherein the backtrack agent iteratively re-invokes at least one of the document synthesis agent, the code generation agent, the legacy simulation agent, and the test data agent until the trust score for a chunk of the plurality of chunks meets or exceeds a threshold.

3. The method of claim 2, wherein the threshold is ninety percent and the trust score comprises a weighted combination of a unit test success, a legacy-to-modern output equivalence, a semantic consistency with the structured documentation, and an execution coverage.

4. The method of claim 1, wherein the graph database stores nodes representing the plurality of chunks, entities, code modules, test runs, and documentation artifacts, and stores relationships representing entity usage by the plurality of chunks, validation of code modules by test runs, and the code lineage.

5. The method of claim 1, wherein segmenting comprises analyzing one or more of a call graph, a control flow construct, a file boundary, and a transaction boundary, to produce a chunk boundary between at least two chunks of the plurality of chunks that optimize semantic cohesion and testability.

6. The method of claim 1, wherein regenerating the legacy program logic comprises compiling code reconstructed from the pseudocode and executing the reconstructed code in an emulated mainframe sandbox.

7. The method of claim 1, further comprising comparing, by the score keeper agent, field-level or record-level output equivalence between the regenerated legacy program logic and the modern code using an identical test input, and producing a diagnostic deltas that guides the backtrack agent's selective initiating of the retry.

8. A system for generative artificial intelligence assisted mainframe modernization, comprising:
one or more processors executing one or more instructions; and
a memory storing the one or more instructions that, when executed by the one or more processors, cause the system to implement:
a chunker engine configured to segment legacy code into a plurality of chunks;
a document synthesis agent configured to extract an entity, a control structure, and a pseudocode from the plurality of chunks to generate structured documentation;
a test data agent configured to interface with a mainframe source to obtain a real input dataset and a real output dataset aligned to the entities;
a legacy simulation agent configured to reconstruct and execute legacy logic in a sandbox to form a reconstructed legacy logic;
a code generation agent configured to produce modern modular code and a unit test from the structured documentation;
a test runner agent configured to execute the reconstructed legacy logic and the modern modular code using a common dataset;
a score keeper agent configured to compute a trust score based at least on behavioral parity and a test outcome;
a graph database configured to persist one or more of an artifact, a lineage, a trace, and the trust score; and
a backtrack agent configured to identify a failed step and selectively re-trigger one or more of the document synthesis agent, the test data agent, the legacy simulation agent, the code generation agent, the test runner agent, and the score keeper agent to increase the trust score.

9. The system of claim 8, further comprising a vision model agent configured to parse architecture diagrams and produce a parsed architecture representation including a component, a service boundary, and a data flow to be merged with the structured documentation.

10. The system of claim 8, wherein the code generation agent is further configured to generate an integration test, a unit test, and a modular code conforming to a service-oriented framework.

11. The system of claim 8, wherein the graph database is further configured to maintain versioned lineage between a legacy artifact and a corresponding modern artifact, a test run, and a trust score history.

12. The system of claim 8, further comprising a simulation agent configured to generate a synthetic test dataset for a plurality of scenarios not covered by the real input dataset and the real output dataset, the synthetic test dataset being constrained by a plurality of schemas associated with an entity schema stored in the graph database.

13. The system of claim 8, wherein the backtrack agent utilizes a dependency relationship stored in the graph database to localize a cause of failure to a chunk of the plurality of chunks and to trigger a targeted selected agent.

14. The system of claim 8, wherein the score keeper agent stores a trust score breakdown including a contribution from a unit test pass rate, a legacy-to-modern output parity, a semantic alignment to the structured documentation, and a diagram alignment, together with a confidence trace in the graph database.

15. A non-transitory computer-readable medium storing instructions that, when executed by one or more processors, cause a computing system to perform a reimagine phase of generative artificial intelligence assisted mainframe modernization, the instructions comprising:
receiving refined documentation for a legacy application;
parsing, by a vision model agent, an uploaded architecture diagram to infer one or more of a service, an API, a data store, and a message flow;
merging parsed architectural information with the refined documentation from a parsed architectural component from the parsed uploaded architecture diagram to form merged information;
generating, by a code generation agent, a modular modern code, a service orchestration, and an associated test in accordance with the merged information;
generating, by a simulation agent, synthetic test data aligned with an entity schema and an architectural flow;
executing, by a test runner agent, the modular modern code using the synthetic test data;
computing, by a score keeper agent, a trust score based at least on a test success of the associated test and a diagram-to-code consistency;
persisting, by a graph database, a lineage, a trace, and a score; and
revalidating, by a backtrack agent, a subcomponent responsive to the trust score being below a threshold.

16. The non-transitory computer-readable medium of claim 15, wherein computing the trust score further comprises evaluating the diagram-to-code consistency by verifying that a service, an endpoint, and a data path inferred from the one or more uploaded architecture diagrams are represented in the generated modular modern code.

17. The non-transitory computer-readable medium of claim 15, further comprising generating a lineage mapping between a legacy chunk and the modular modern code and storing the generated lineage mapping in the graph database to enable bidirectional traceability.

18. The non-transitory computer-readable medium of claim 15, wherein generating the modular modern code further comprises producing one or more of an API, a message queue integration, and a persistence adapter that correspond to the parsed architectural information.

19. The non-transitory computer-readable medium of claim 15, wherein generating the synthetic test data further comprises producing an edge cases and a permutation derived from one or more of an entity constraint, a referential relationship, and a historical distribution persisted in the graph database.

20. The non-transitory computer-readable medium of claim 15, further comprising maintaining an explainable audit trail by recording, in the graph database, versioned documentation, a code artifact, a diagram parse, an execution trace, a test outcome, and a trust score revision associated with each revalidation cycle.
